(19) United States
(12) Patent Application Publication
(10) Pub. No.: US 2016/0312014 A1
(43) Pub. Date: Oct. 27, 2016

(54) TIRE FOR VEHICLES INTENDED TO BEAR HEAVY LOADS

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: FÉRDÉRIC LEMERLE, CLERMONT-FERRAND (FR); JOSÉ-CARLOS ARAUJO DA SILVA, CLERMONT-FERRAND (FR)

(21) Appl. No.: 15/105,918

(22) PCT Filed: Dec. 19, 2014
(86) PCT No.: PCT/EP2014/078701

§ 371 Date: Jun. 17, 2016

(30) Foreign Application Priority Data
Dec. 20, 2013 (FR) 1363150

(51) Int. Cl. C08L 9/00; C08L 9/06

(52) U.S. Cl. CPC C08L 9/00; C08L 9/06; C08L 2205/02

(57) ABSTRACT

The tread of a tire for vehicles which are intended to bear heavy loads comprises a composition based on at least an elastomer matrix comprising a first diene elastomer and a thermoplastic styrene elastomer which represents at most 50% by weight of the elastomer matrix, a reinforcing filler which comprises from 20 to 50 phr of a silica, which silica represents at least 50% by weight of the reinforcing filler which varies within a range extending from 25 to 60 phr, a coupling agent and a crosslinking system. The first diene elastomer is chosen from the group consisting of polybutadienes, butadiene copolymers and mixtures thereof. The thermoplastic styrene elastomer comprises at least one rigid styrene segment and at least one flexible diene segment, which at least one flexible diene segment comprises at least 20% by weight of conjugated diene units, it being possible for the conjugated diene units to be all or in part hydrogenated.

The field of the present invention is that of tyres for vehicles which are intended to bear heavy loads, in particular buses, lorries, agricultural vehicles or civil engineering vehicles.

These tyres are provided with treads which exhibit, in comparison with the thicknesses of the treads of the tyres for light vehicles, in particular for passenger vehicles or vans, great thicknesses of rubber material. Typically, the wearing part of the tread of a heavy-duty vehicle has a thickness of at least 15 mm and that of a civil engineering vehicle is at least 30 mm, indeed even up to 120 mm.

During running, a tread is subjected to mechanical stresses and to attacks resulting from direct contact with the ground. In the case of a tyre fitted to a vehicle bearing heavy loads, the mechanical stresses and the attacks undergone by the tyre are magnified under the effect of the weight borne by the tyre. The consequence of this is that the incipient cracks which are created in the tread under the effect of these strains and these attacks have a tendency to further propagate at the surface of or inside the tread. Crack propagation in the tread can result in damage to the tread and can thus reduce the lifetime of the tread or of the tyre.

A tyre running over a stony ground surface is highly exposed to incipient cracks. The actual aggressive nature of the stony ground surface exacerbates not only this type of attack on the tread but also its consequences with regard to the tread. This is particularly true for the tyres equipping civil engineering vehicles which are moving about generally in mines. This is also true for the tyres which are fitted to agricultural vehicles, due to the stony ground surface of arable land. The tyres which equip heavy-duty vehicles of worksites, which are moving both on stony ground surfaces and on bituminous ground surfaces, also experience these same attacks. Due to the two aggravating factors, which are the weight borne by the tyre and the aggressive nature of the running ground surface, the resistance to crack propagation of a tread of a tyre for a civil engineering vehicle, an agricultural vehicle or a worksite heavy-duty vehicle proves to be crucial in minimizing the impact of the attacks undergone by the tread.

It is thus important to have available tyres for vehicles bearing heavy loads, the tread of which exhibits a resistance to crack propagation which is sufficiently strong to minimize the effect of an incipient crack on the lifetime of the tread. In order to solve this problem, tyre manufacturers use, for example, natural rubber in the treads due to the properties of resistance to crack propagation of natural rubber, as mentioned in Table 3.7, Comparison of elastomers properties, pp 162-163, Rubber Technology Handbook, Hofmann, Hanser Publishers (1989).

The Applicant Companies have discovered that the combined use of a certain content of silica, of a polybutadiene or of a butadiene copolymer and of a certain content of a specific thermoplastic elastomer in a tread makes it possible to improve the resistance to crack propagation of the tread of a tyre for a vehicle intended to bear large loads, without substantial damage to the other performances of the tread, which are the wear and the rolling resistance.

Thus, a first subject-matter of the invention is a tyre for vehicles which are intended to bear heavy loads, the tread of which comprises a composition based on at least:
an elastomer matrix comprising a first diene elastomer and a thermoplastic styrene elastomer which represents at most 50% by weight of the elastomer matrix, which first diene elastomer is chosen from the group consisting of polybutadienes, butadiene copolymers and their mixtures, which thermoplastic styrene elastomer comprises at least one rigid styrene segment and at least one flexible diene segment, which at least one flexible diene segment comprises at least 20% by weight of conjugated diene units, it being possible for the conjugated diene units to be all or in part hydrogenated, a reinforcing filler which comprises from 20 to 50 phr of a silica, which silica represents at least 50% by weight of the reinforcing filler, the content of reinforcing filler varying within a range extending from 25 to 60 phr,
a coupling agent,
a crosslinking system.

Another subject-matter of the invention is a process for preparing the tyre in accordance with the invention.

### I. MEASUREMENTS AND TESTS USED

### Resistance to Crack Propagation:

The rate of cracking was measured on test specimens of rubber compositions using a cyclic fatigue device (Elastomer Test System) of the 381 type from MTS, as explained below.

The resistance to cracking is measured using repeated tensile actions on a test specimen initially accommodated (after a first tensile cycle) and then notched. The tensile test specimen is composed of a rubber plaque of parallelepipedal shape, for example with a thickness of between 1 and 2 mm, with a length between 130 and 170 mm and with a width between 10 and 15 mm, the two side edges each being covered in the direction of the length with a cylindrical rubber strip (diameter 5 mm) making possible anchoring in the jaws of the tensile testing device. The test specimens thus prepared are tested in the fresh state. The test was carried out in air, at a temperature of 20° C. After accommodation, 3 very fine notches with a length of between 15 and 20 mm are produced using a razor blade, at mid-width and aligned in the direction of the length of the test specimen, one at each end and one at the centre of the latter, before starting the test. At each tensile cycle, the degree of deformation of the test specimen is automatically adjusted so as to keep the energy restitution level (amount of energy released during the progression of the crack) constant at a value of less than or equal to approximately 500 J/m². The crack propagation rate is measured in nanometres per cycle. The resistance to crack propagation will be expressed in relative units (r.u.) by dividing the propagation rate of the control by that of the mixture, the rates being measured at the same energy restitution level. A value greater than that of the control, arbitrarily set at 100, indicates an improved result, that is to say a greater resistance to crack propagation.

### II—DETAILED DESCRIPTION OF THE INVENTION

In the present description, unless expressly indicated otherwise, all the percentages (%) shown are % by weight. The abbreviation “phr” means parts by weight per hundred parts of elastomers present in the elastomer matrix, the elastomer matrix denoting all of the elastomers present in the rubber composition.

Furthermore, any interval of values denoted by the expression “between a and b” represents the range of values greater than “a” and lower than “b” (that is to say, limits a and b excluded), whereas any interval of values denoted by the expression from a to b″ means the range of values extending from “a” up to “b” (that is to say, including the strict limits a and b).

The expression “composition based on” should be understood as meaning, in the present description, a composition comprising the mixture and/or the in situ reaction product of the various constituents used, some of these base constituents (for example the elastomer, the filler or other additive conventionally used in a rubber composition intended for the manufacture of tyres) being capable of reacting or intended to react with one another, at least in part, during the various phases of manufacture of the composition intended for the manufacture of tyres.

The elastomer matrix of the rubber composition has the essential characteristic of comprising a first diene elastomer chosen from the group consisting of polybutadienes (BRs), butadiene copolymers and their mixtures.

Suitable in particular as polybutadienes are those having a content of 1,2-units of between 4% and 80% by weight of the weight of the polybutadiene or those having a content of cis-1,4-bonds of at least 90% by weight of the weight of the polybutadiene.

Suitable in particular as butadiene copolymers are the copolymers of butadiene and styrene (SBR). The copolymers can be prepared in emulsion (ESBR) or in solution (SSBR). Mention may be made of butadiene/styrene copolymers and in particular of those having a glass transition temperature Tg, measured according to ASTM D3418, of between 0° C. and −90° C. and more particularly between −10° C. and −80° C., a styrene content of between 5% and 60% by weight and more particularly between 5% and 40%, a content (mol %) of 1,2-bonds of the butadiene part of between 4% and 75% of the butadiene part and a content (mol %) of trans-1,4-bonds of between 10% and 80% of the butadiene part.

The first diene elastomer, whether it is a polybutadiene or a butadiene copolymer, can be modified by a modifying agent, such as, for example, a coupling, star-branching or functionalizing agent. Mention may be made, as modifying agent, of compounds comprising a C—Sn bond or those comprising an amine, silanol or alkoxysilane functional group. Such elastomers are, for example, described in Patents EP 0 778 311 B1, EP 0 890 607 B1, EP 0 692 492 B1, EP 1 000 970 B1 and EP 1 457 501 B1 or Patent Applications WO 2009/000750 and WO 2009/133068.

According to a preferred embodiment of the invention, the first diene elastomer is a polybutadiene, preferably exhibiting a content of cis-1,4-bonds of greater than or equal to 90% by weight of the weight of polybutadiene. This preferred embodiment of the invention can be combined with any one of the embodiments of the invention.

According to one embodiment of the invention, the first diene elastomer represents at least 50% of the difference between the weight of the elastomer matrix and the weight of the thermoplastic styrene elastomer, which amounts to saying that the first diene elastomer exhibits a fraction by weight of greater than or equal to 50%, with respect to the total weight of the non-thermoplastic elastomers of the elastomer matrix. According to this embodiment, suitable as elastomer matrix is, for example, a mixture consisting of 40% by weight of the thermoplastic styrene elastomer, of 45% by weight of the first diene elastomer and of 15% by weight of a second diene elastomer, the percentages being calculated on the basis of the total weight of the elastomer matrix.

According to another embodiment of the invention, the first diene elastomer represents at least 50% by weight of the elastomer matrix. According to this embodiment, suitable as elastomer matrix is, for example, a mixture consisting of 40% by weight of the thermoplastic styrene elastomer, of 55% by weight of the first diene elastomer and of 5% by weight of a second diene elastomer, the percentages being calculated on the basis of the total weight of the elastomer matrix.

Second diene elastomer (or without distinction rubber) should be understood, in a known way, as meaning an (or several) elastomer composed, at least in part (i.e., a homopolymer or a copolymer), of diene monomer units (monomers bearing two conjugated or non-conjugated carbon-carbon double bonds), the second diene elastomer being different from the first diene elastomer and not being a thermoplastic styrene elastomer.

According to a preferred embodiment of the invention, only the first diene elastomer and the thermoplastic styrene elastomer constitute the elastomer matrix, which means that the elastomer matrix does not contain other elastomers than the first diene elastomer and the thermoplastic styrene elastomer.

The thermoplastic styrene elastomer comprises at least one rigid styrene segment and at least one flexible diene segment comprising at least 20% by weight of conjugated diene units, it being possible for the conjugated diene units to be all or in part hydrogenated. The rigid and flexible segments can be positioned linearly, or in a star or branched configuration.

A flexible segment refers to a polymer block of elastomer type and a rigid segment refers to a polymer block of thermoplastic type.

According to one embodiment of the invention, the thermoplastic styrene elastomer is a diblock. The diblock comprises just one rigid styrene segment connected to just one flexible diene segment.

According to a preferred embodiment of the invention, the thermoplastic styrene elastomer comprises at least two rigid styrene segments. According to this preferred embodiment of the invention, generally at least two ends of chains of the thermoplastic styrene elastomer are each provided with a rigid styrene segment and the rigid styrene segments are connected via the flexible diene segment or segments. According to this preferred embodiment of the invention, the thermoplastic styrene elastomer is preferably a triblock. The triblock is then composed of two rigid styrene segments and of one flexible diene segment.

In the case where the thermoplastic styrene elastomer is a diblock, the designation of “the at least one rigid segment” denotes the rigid segment present in the thermoplastic styrene elastomer. In the cases other than a diblock, for example in the case of a triblock, the designation of “the at least one rigid segment” denotes the rigid segments present in the thermoplastic styrene elastomer.

In the case where the thermoplastic styrene elastomer is a diblock or a triblock, the designation of “the at least one flexible segment” denotes the flexible segment present in the thermoplastic styrene elastomer. In the case where the thermoplastic styrene elastomer is neither a diblock nor a triblock, the designation of “the at least one flexible segment” denotes the flexible segments present in the thermoplastic styrene elastomer.

The at least one rigid styrene segment is the homopolymer of a styrene monomer or the block or random copolymer of several styrene monomers or also the copolymer of one or more styrene monomers and of another non-styrene monomer, such as a 1,3-diene.

Styrene monomer should be understood, in the present description, as meaning styrene or a substituted styrene. Mention may be made, among substituted styrenes, for example, of methylstyrenes (for example, o-methylstyrene, m-methylstyrene or p-methylstyrene, α-methylstyrene, α,2-dimethylstyrene, α,4-dimethylstyrene or diphenylethylene), para-(tert-butyl)styrene, chlorostyrenes (for example, o-chlorostyrene, m-chlorostyrene, p-chlorostyrene, 2,4-dichlorostyrene, 2,6-dichlorostyrene or 2,4,6-trichlorostyrene), bromostyrenes (for example, o-bromostyrene, m-bromostyrene, p-bromostyrene, 2,4-dibromostyrene, 2,6-dibromostyrene or 2,4,6-tribromostyrene), fluorostyrenes (for example, o-fluorostyrene, m-fluorostyrene, p-fluorostyrene, 2,4-difluorostyrene, 2,6-difluorostyrene or 2,4,6-trifluorostyrene) or also para-hydroxystyrene.

According to a preferred embodiment of the invention, the at least one rigid styrene segment exhibits a glass transition temperature of greater than 80° C. Preferably, the at least one rigid styrene segment is a polystyrene.

The at least one flexible diene segment comprises at least 20% by weight of conjugated diene monomer units (also known as conjugated diene units). The at least one flexible diene segment can be the homopolymer of a conjugated diene or the block or random copolymer of several conjugated dienes or also the copolymer of one or more conjugated dienes and of at least one other non-diene monomer, such as a styrene monomer.

The content of conjugated diene units which form the flexible diene segment is preferably at least 50%, more preferably at least 60% and more preferably still at least 70% by weight of the weight of the flexible diene segment. Advantageously, it is at least 80% by weight of the weight of the flexible diene segment. These contents, whether or not they are preferred, apply to any one of the embodiments of the invention.

Suitable in particular as conjugated diene units are 1,3-butadiene units and isoprene units. The at least one flexible diene segment can be a polybutadiene, a polyisoprene or a copolymer of 1,3-butadiene and of isoprene. The copolymer of 1,3-butadiene and of isoprene can be block or random in nature.

Suitable as thermoplastic styrene elastomer are diblock copolymers, such as styrene/butadiene (SB), styrene/isoprene (SI) or styrene/butadiene/isoprene (SBI) block copolymers, or the mixture of these copolymers. In this designation, the flexible diene block is a random or block copolymer.

Suitable in particular as thermoplastic styrene elastomer are copolymers, such as styrene/butadiene/styrene (SBS), styrene/isoprene/styrene (SIS) or styrene/butadiene/isoprene/styrene (SBIS) block copolymers, or the mixture of these copolymers. In this designation, the flexible diene block is a random or block copolymer. Very particularly suitable is a styrene/butadiene/isoprene/styrene (SBIS) block copolymer.

According to a first alternative form of the invention, a fraction of the diene units of the at least one flexible diene segment is hydrogenated. A person skilled in the art will understand that he can equivalently use a thermoplastic styrene elastomer, the double bonds of a fraction of the diene units of the flexible diene segment of which will have been reduced to a single bond by a process other than a hydrogenation. Mention may be made, among the processes which make it possible to reduce the double bonds of the diene units to a single bond, of reductions with an aluminium hydride or with diimine, for example.

According to a second alternative form of the invention, all of the diene units of the at least one flexible diene segment are hydrogenated. A person skilled in the art will understand that he can equivalently use a thermoplastic styrene elastomer, the double bonds of all of the diene units of the flexible diene segment of which will have been reduced to a single bond by a process other than a hydrogenation.

According to this second alternative form of the invention, suitable as thermoplastic elastomer are styrene/ethylene/butylene (SEB), styrene/ethylene/propylene (SEP) or styrene/ethylene/ethylene/propylene (SEEP) block copolymers or the mixtures of these copolymers. In this designation, the hydrogenated flexible diene block is a random or block copolymer.

According to this second alternative form of the invention, also suitable as thermoplastic elastomer are styrene/ethylene/butylene/styrene (SEBS), styrene/ethylene/propylene/styrene (SEPS) or styrene/ethylene/ethylene/propylene/styrene (SEEPS) block copolymers or the mixtures of these copolymers. In this designation, the hydrogenated flexible diene block is a random or block copolymer.

Any one of the embodiments of the invention applies to the first alternative form of the invention or to the second alternative form of the invention.

Also suitable as thermoplastic styrene elastomer are the mixtures of an abovementioned triblock copolymer and of an abovementioned diblock copolymer. This is because the triblock copolymer can comprise a minor fraction by weight of diblock copolymer consisting of a rigid styrene segment and of a flexible diene segment, the rigid block and the flexible block being respectively of the same chemical nature, in particular of the same microstructure, as the rigid and flexible blocks of the triblock. The presence of the diblock copolymer in the triblock copolymer generally results from the process of synthesis of the triblock copolymer, which can result in the formation of byproduct, such as the diblock copolymer. Generally, the percentage of diblock copolymer in the triblock copolymer does not exceed 40% by weight of triblock copolymer.

According to a preferred embodiment of the invention, the content by weight of the at least one rigid styrene segment is between 5 and 40% of the weight of the thermoplastic styrene elastomer. Below the minimum indicated, there is a risk of the thermoplastic nature of the thermoplastic styrene elastomer being substantially reduced while, above the recommended maximum, the elasticity of the composition can be affected. For these reasons, the content by weight of the at least one rigid styrene segment in the thermoplastic styrene elastomer is preferably within a range extending from 10 to 35%, more preferably from 10 to 20%, of the weight of the thermoplastic styrene elastomer. These contents, whether or not they are preferred, apply to any one of the embodiments of the invention, very particularly when the polystyrene forms the at least one rigid styrene segment of the thermoplastic styrene elastomer.

The number-average molar mass (denoted Mn) of the thermoplastic styrene elastomer is preferably between 50 000 and 500 000 g/mol, more preferably between 60 000 and 450 000 g/mol and more preferably still between 80 000 and 300 000 g/mol. Advantageously, it is between 100 000 and 200 000 g/mol. These preferred ranges of number-average molar mass values apply whatever the embodiment of the invention.

The molar mass is determined, in a known way, by size exclusion chromatography (SEC). The sample is dissolved beforehand in tetrahydrofuran at a concentration of approximately 1 g/I and then the solution is filtered through a filter with a porosity of 0.45 μm before injection. The apparatus used is a Waters Alliance chromatographic line. The elution solvent is tetrahydrofuran, the flow rate is 0.7 ml/min, the temperature of the system is 35° C. and the analytical time is 90 min. A set of four Waters columns in series, with the Styragel tradenames (HMW7, HMW6E and two HT6E), is used. The injected volume of the solution of the polymer sample is 100 μl. The detector is a Waters 2410 differential refractometer and its associated software, for making use of the chromatographic data, is the Waters Millennium system. The calculated number-average molar masses are relative to a calibration curve produced with polystyrene standards.

The thermoplastic styrene elastomer is present in a proportion by weight of at most 50% of the weight of the elastomer matrix of the rubber composition of the tread. Above the maximum value indicated, there is no longer a benefit with regard to the resistance to crack propagation of the rubber composition forming the tread of a tyre intended to bear heavy loads. The content of thermoplastic styrene elastomer varies within a range extending preferably from 5 to 50%, more preferably from 10 to 45% and more preferably still from 20 to 45% by weight of the weight of the elastomer matrix. Advantageously, it varies from 25 to 45% by weight of the weight of the elastomer matrix. When the thermoplastic styrene elastomer is a mixture of unsaturated thermoplastic styrene elastomers in accordance with the invention, the contents shown apply to the mixture and not to each of the thermoplastic styrene elastomers. These contents, whether or not they are preferred, apply to any one of the embodiments of the invention.

According to a specific embodiment of the invention, the thermoplastic styrene elastomer exhibits a glass transition temperature of less than −20° C. This glass transition temperature is generally attributed to the glass temperature of the flexible diene segment of the thermoplastic styrene elastomer. The glass transition temperature is measured by means of a differential calorimeter (differential scanning calorimeter) according to Standard ASTM D3418 (1999). According to this specific embodiment of the invention, the thermoplastic styrene elastomer exhibits a Tg preferably of less than −30° C., more preferably of less than −40° C. and more preferably still of less than −50° C.

The reinforcing filler can be any type of “reinforcing” filler known for its abilities to reinforce a rubber composition which can be used for the manufacture of tyres, for example an organic filler, such as carbon black, a reinforcing inorganic filler, such as silica, with which is combined, in a known way, a coupling agent, or also a mixture of these two types of fillers.

A reinforcing filler typically consists of nanoparticles, the (weight-)average size of which is less than a micrometre, generally less than 500 nm, generally between 20 and 200 nm, in particular and more preferably between 20 and 150 nm.

According to the present invention, the reinforcing filler is present according to an amount which varies from 25 to 60 phr. The reinforcing filler comprises a silica, the content of which varies from 20 to 50 phr and which represents at least 50% by weight of the reinforcing filler. Silica is understood to mean one or more silicas.

The term “silica” should be understood here as meaning any silica capable of reinforcing, by itself alone, without means other than an intermediate coupling agent, a rubber composition intended for the manufacture of pneumatic tyres, in other words capable of replacing, in its reinforcing role, a conventional tyre-grade carbon black. A suitable reinforcing silica is any reinforcing silica known to a person skilled in the art, in particular any precipitated or fumed silica exhibiting a BET specific surface and a CTAB specific surface both of less than 450 m²/g, preferably from 30 to 400 m²/g, in particular between 60 and 300 m²/g. Mention may be made, as example of silica of use for the requirements of the invention, of the Ultrasil VN3 silica sold by Evonik. Mention will be made, as highly dispersible precipitated silicas (“HDSs”), for example, of the Ultrasil 7000 and Ultrasil 7005 silicas from Degussa, the Zeosil 1165MP, 1135MP and 1115MP silicas from Rhodia, the Hi-Sil EZ150G silica from PPG, the Zeopol 8715, 8745 and 8755 silicas from Huber or the silicas having a high specific surface as described in Application WO 03/016387. In the present account, as regards the silica, the BET specific surface is determined in a known way by gas adsorption using the Brunauer-Emmett-Teller method described in The Journal of the American Chemical Society, Vol. 60, page 309, February 1938, more specifically according to French Standard NF ISO 9277 of December 1996 (multipoint (5 point) volumetric method—gas: nitrogen—degassing: 1 hour at 160° C.—relative pressure p/po range: 0.05 to 0.17). The CTAB specific surface is the external surface determined according to French Standard NF T 45-007 of November 1987 (method B).

The physical state under which the silica is provided is not important, whether it is in the form of a powder, microbeads, granules or also beads.

A person skilled in the art will understand that use might be made, as filler equivalent to the reinforcing silica described in the present section, of a reinforcing filler of another nature, in particular organic nature, such as carbon black, provided that this reinforcing filler is covered with a silica layer requiring the use of a coupling agent in order to establish the bond between the filler and the elastomer. Mention may be made, by way of example, for example, of carbon blacks for tyres, such as described, for example, in patent documents WO 96/37547 and WO 99/28380.

According to any one embodiment of the invention, the silica preferably represents more than 50% by weight of the reinforcing filler

According to one embodiment of the invention, the reinforcing filler additionally comprises a carbon black. A carbon black is understood to mean one or more carbon blacks.

According to another embodiment of the invention, the reinforcing filler consists of a mixture of silica and carbon black. In this case, the rubber composition does not comprise other reinforcing fillers than the silica and the carbon black.

When the rubber composition comprises a carbon black, the carbon black preferably exhibits a BET specific surface of at least 90 m²/g. The blacks conventionally used in tyres or their treads (“tyre-grade” blacks) are suitable as such. Mention will more particularly be made, among the latter, of the reinforcing carbon blacks of the 100, 200 or 300 series (ASTM grade), such as, for example, the N115, N134, N234 or N375 blacks. Preferably, the carbon black exhibits a BET of at least 100 m²/g. The carbon blacks can be used in the isolated state, as available commercially, or in any other form, for example as support for some of the rubber additives used. The carbon blacks might, for example, be already incorporated in an isoprene elastomer in the form of a masterbatch (see, for example, Application WO 97/36724 or WO 99/16600). The BET specific surface of the carbon blacks is measured according to Standard D6556-10 [multipoint (at a minimum 5 points) method—gas: nitrogen—relative pressure p/po range: 0.1 to 0.3].

In order to couple the silica to the diene elastomer, use is made, in a well-known way, of an at least bifunctional coupling agent, in particular a silane, (or bonding agent) intended to provide a satisfactory connection, of chemical and/or physical nature, between the inorganic filler (surface of its particles) and the diene elastomer. Use is made in particular of at least bifunctional organosilanes or polyorganosiloxanes.

Use is made in particular of silane polysulphides, referred to as “symmetrical” or “unsymmetrical” depending on their specific structure, such as described, for example, in Applications WO 03/002648 (or US 2005/016651) and WO 03/002649 (or US 2005/016650).

Particularly suitable, without the definition below being limiting, are silane polysulphides corresponding to the general formula (V):

Z-A-Sₓ-A-Z (V)
in which:
   x is an integer from 2 to 8 (preferably from 2 to 5);
   the A symbols, which are identical or different, represent a divalent hydrocarbon radical (preferably a C₁-C₁₈ alkylene group or a C₆-C₁₂ arylene group, more particularly a C₁-C₁₀, in particular C₁-C₄, alkylene, especially propylene);
   the Z symbols, which are identical or different, correspond to one of the three formulae below:

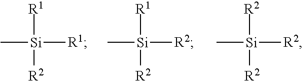

in which:
   the R¹ radicals, which are substituted or unsubstituted and identical to or different from one another, represent a C₁-C₁₈ alkyl, C₅-C₁₈ cycloalkyl or C₆-C₁₈ aryl group (preferably C₁-C₆ alkyl, cyclohexyl or phenyl groups, in particular C₁-C₄ alkyl groups, more particularly methyl and/or ethyl);
   the R² radicals, which are substituted or unsubstituted and identical to or different from one another, represent a C₁-C₁₈ alkoxyl or C₅-C₁₈ cycloalkoxyl group (preferably a group chosen from C₁-C₈ alkoxyls and C₅-C₈ cycloalkoxyls, more preferably still a group chosen from C₁-C₄ alkoxyls, in particular methoxyl and ethoxyl).

In the case of a mixture of alkoxysilane polysulphides corresponding to the above formula (I), in particular normal commercially available mixtures, the mean value of the “x” indices is a fractional number preferably of between 2 and 5, more preferably of approximately 4. However, the invention can also advantageously be carried out, for example, with alkoxysilane disulphides (x=2).

Mention will more particularly be made, as examples of silane polysulphides, of bis((C₁-C₄)alkoxyl(C₁-C₄)alkylsilyl(C₁-C₄)alkyl) polysulphides (in particular disulphides, trisulphides or tetrasulphides), such as, for example, bis(3-trimethoxysilylpropyl) or bis(3-triethoxysilylpropyl) polysulphides. Use is made in particular, among these compounds, of bis(3-triethoxysilylpropyl) tetrasulphide, abbreviated to TESPT, of formula [(C₂H₅O)₃Si(CH₂)₃S₂]₂, or bis(3-triethoxysilylpropyl) disulphide, abbreviated to TESPD, of formula [(C₂H₅O)₃Si(CH₂)₃S]₂.

Mention will in particular be made, as coupling agent other than alkoxysilane polysulphide, of bifunctional POSs (polyorganosiloxanes), or else of hydroxysilane polysulphides, such as described in Patent Applications WO 02/30939 (or U.S. Pat. No. 6,774,255) and WO 02/31041 (or US 2004/051210), or else of silanes or POSs bearing azodicarbonyl functional groups, such as described, for example, in Patent Applications WO 2006/125532, WO 2006/125533 and WO 2006/125534.

The content of coupling agent is advantageously less than 10 phr, it being understood that it is generally desirable to use as little as possible of it. Typically, the content of coupling agent represents from 0.5% to 15% by weight, with respect to the amount of inorganic filler. Its content is preferably between 0 and 8 phr, more preferably within a range extending from 0.5 to 7.5 phr. This content is easily adjusted by a person skilled in the art depending on the content of inorganic filler used in the composition.

The rubber composition in accordance with the invention can also comprise, in addition to the coupling agents, coupling activators, agents for covering the inorganic fillers or more generally processing aids capable, in a known way, by virtue of an improvement in the dispersion of the filler in the rubber matrix and of a lowering in the viscosity of the compositions, of improving their ease of processing in the raw state, these processing aids being, for example, hydrolysable silanes, such as alkylalkoxysilanes (in particular alkyltriethoxysilanes), polyols, polyethers (for example, polyethylene glycols), primary, secondary or tertiary amines (for example, trialkanolamines), hydroxylated or hydrolysable POSs, for example α,ω-dihydroxypolyorganosiloxanes (in particular α,ω-dihydroxypolydimethylsiloxanes), or fatty acids, such as, for example, stearic acid.

The rubber composition can also comprise all or a portion of the usual additives customarily used in elastomer compositions, such as, for example, plasticizers, pigments, protective agents, such as antiozone waxes, chemical antiozonants or antioxidants, antifatigue agents, a crosslinking system, vulcanization accelerators or retardants, or vulcanization activators. According to any one embodiment of the invention, the crosslinking system is preferably based on sulphur but it can also be based on sulphur donors, on peroxide, on bismaleimides or on their mixtures.

The rubber composition can be manufactured in appropriate mixers, using two successive phases of preparation well known to a person skilled in the art: a first phase of thermomechanical working or kneading (“non-productive” phase) at high temperature, up to a maximum temperature of between 130° C. and 200° C., followed by a second phase of mechanical working (“productive” phase) down to a lower temperature, typically below 110° C., for example between 40° C. and 100° C., during which finishing phase the crosslinking system is incorporated.

The process for manufacturing the tyre in accordance with the invention comprises, for example, the following stages:
adding, during a first “non-productive” stage, to the first diene elastomer, the thermoplastic styrene elastomer, the reinforcing filler and the coupling agent, by kneading thermomechanically until a maximum temperature of between 130° C. and 200° C. is reached,
cooling the combined mixture to a temperature of less than 70° C.,
subsequently incorporating the crosslinking system,
kneading everything up to a maximum temperature of less than 90° C. in order to obtain a mixture,
then calendering or extruding the mixture obtained in order to form a tread.

Whatever the embodiment of the invention, the tyre in accordance with the invention is preferably a tyre for off-road vehicles, that is to say a tyre which runs over a stoney ground surface, such as, for example, civil engineering vehicles, worksite heavy-duty vehicles or agricultural vehicles. The tyre is in particular a tyre for a civil engineering vehicle, whatever the embodiment of the invention.

The invention relates to the tyres described above, both in the raw state (that is to say, before curing) and in the cured state (that is to say, after crosslinking or vulcanization).

1.-24. (canceled)

25. A tire for vehicles which are intended to bear heavy loads, the tread of which comprises a composition based on at least:
an elastomer matrix comprising a first diene elastomer and a thermoplastic styrene elastomer which represents at most 50% by weight of the elastomer matrix, said first diene elastomer being chosen from the group consisting of polybutadienes, butadiene copolymers and mixtures thereof, said thermoplastic styrene elastomer comprising at least one rigid styrene segment and at least one flexible diene segment, and said at least one flexible diene segment comprising at least 20% by weight of conjugated diene units, it being possible for the conjugated diene units to be all or in part hydrogenated;
a reinforcing filler which comprises from 20 to 50 phr of a silica, said silica representing at least 50% by weight of the reinforcing filler, the content of reinforcing filler varying within a range extending from 25 to 60 phr;
a coupling agent; and
a crosslinking system.

26. The tire according to claim 25, wherein the first diene elastomer represents at least 50% of the difference between the weight of the elastomer matrix and the weight of the thermoplastic styrene elastomer.

27. The tire according to claim 25, wherein the first diene elastomer represents at least 50% by weight of the elastomer matrix.

28. The tire according to claim 25, wherein the elastomer matrix consists of a mixture of the first diene elastomer and of the thermoplastic styrene elastomer.

29. The tire according to claim 25, wherein the content of thermoplastic styrene elastomer represents from 5 to 50% by weight of the weight of the elastomer matrix.

30. The tire according to claim 29, wherein the content of thermoplastic styrene elastomer represents from 10 to 45% by weight of the weight of the elastomer matrix.

31. The tire according to claim 30, wherein the content of thermoplastic styrene elastomer represents from 20 to 45% by weight of the weight of the elastomer matrix.

32. The tire according to claim 31, wherein the content of thermoplastic styrene elastomer represents from 25 to 45% by weight of the weight of the elastomer matrix.

33. The tire according to claim 25, wherein the at least one rigid styrene segment exhibits a glass transition temperature of greater than 80° C.

34. The tire according to claim 25, wherein the at least one rigid styrene segment is a polystyrene.

35. The tire according to claim 25, wherein the conjugated diene units of the at least one flexible diene segment are 1,3-butadiene units or isoprene units.

36. The tire according to claim 25, wherein the thermoplastic styrene elastomer is a diblock comprising only one rigid styrene segment connected to only one flexible diene segment.

37. The tire according to claim 36, wherein the thermoplastic styrene elastomer is a styrene/butadiene (SB), styrene/isoprene (SI) or styrene/butadiene/isoprene (SBI) block copolymer or a mixture thereof.

38. The tire according to claim 25, wherein the thermoplastic styrene elastomer comprises at least two rigid styrene segments.

39. The tire according to claim 38, wherein the thermoplastic styrene elastomer is a triblock composed of two rigid styrene segments and of one flexible diene segment.

40. The tire according to claim 39, wherein the thermoplastic styrene elastomer is a styrene/butadiene/styrene (SBS), styrene/isoprene/styrene (SIS) or styrene/butadiene/isoprene/styrene (SBIS) block copolymer or a mixture thereof.

41. The tire according to claim 25, wherein a fraction of the conjugated diene units of the at least one flexible diene segment is hydrogenated.

42. The tire according to claim 25, wherein all of the conjugated diene units of the at least one flexible diene segment are hydrogenated.

43. The tire according to claim 36, wherein all of the conjugated diene units of the at least one flexible diene segment are hydrogenated, and
wherein the thermoplastic styrene elastomer is a styrene/ethylene/butylene (SEB), styrene/ethylene/propylene (SEP) or styrene/ethylene/ethylene/propylene (SEEP) block copolymer or a mixture thereof.

44. The tire according to claim 39, wherein all of the conjugated diene units of the at least one flexible diene segment are hydrogenated, and
wherein the thermoplastic styrene elastomer is a styrene/ethylene/butylene/styrene (SEBS), styrene/ethylene/propylene/styrene (SEPS) or styrene/ethylene/ethylene/propylene/styrene (SEEPS) block copolymer or their mixture.

45. The tire according to claim 25, wherein the thermoplastic styrene elastomer exhibits a glass transition temperature of less than −20° C.

46. The tire according to claim 45, wherein the thermoplastic styrene elastomer exhibits a glass transition temperature of less than −30° C.

47. The tire according to claim 46, wherein the thermoplastic styrene elastomer exhibits a glass transition temperature of less than −40° C.

48. The tire according to claim 47, wherein the thermoplastic styrene elastomer exhibits a glass transition temperature of less than −50° C.

49. The tire according to claim 25, wherein the reinforcing filler comprises a carbon black.

50. The tire according to claim 49, wherein the carbon black has a BET specific surface of at least 90 m²/g.

51. The tire according to claim 50, wherein the carbon black has a BET specific surface of at least 100 m²/g.

52. The tire according to claim 49, wherein the reinforcing filler consists of a mixture of carbon black and silica.

53. The tire according to claim 25, wherein the tire is an off-road tire.

54. The tire according to claim 53, wherein the tire is a tire for a civil engineering vehicle.

55. A process for manufacturing the tire according to claim 25, said process comprising the steps of:
adding, during a first non-productive stage, to the first diene elastomer, the thermoplastic styrene elastomer, the reinforcing filler and the coupling agent, by kneading thermomechanically until a maximum temperature of between 130° C. and 200° C. is reached;
cooling the mixture to a temperature of less than 70° C.;
subsequently incorporating the crosslinking system;
kneading the mixture up to a maximum temperature of less than 90° C.; and
then calendering or extruding the mixture obtained in order to form a tread.
